(19) United States
(12) Patent Application Publication
(10) Pub. No.: US 2023/0072534 A1
(43) Pub. Date: Mar. 9, 2023

(54) PROXY SYSTEM CONFIGURED TO IMPROVE MESSAGE-TO-EXECUTION RATIO OF DISTRIBUTED SYSTEM

(71) Applicant: GX2 Systems, LLC, Chicago, IL (US)

(72) Inventors: David W. Jaberg, Glencoe, IL (US); Anton Kryukov, Buffalo Grove, IL (US); Jason R. Nazarof, Chicago, IL (US); Darek Poczobut-Potchebout, Northbrook, IL (US)

(21) Appl. No.: 17/874,115

(22) Filed: Jul. 26, 2022

Related U.S. Application Data
(63) Continuation-in-part of application No. 17/112,771, filed on Dec. 4, 2020, now abandoned.
Application No. 17/112,771 is a division of application No. 14/555,376, filed on Nov. 26, 2014, now abandoned.
(60) Provisional application No. 61/909,969, filed on Nov. 27, 2013.

(51) Int. Cl. G06F 9/38; G06F 17/18

(52) U.S. Cl. CPC G06F 9/3855; G06F 17/18

(57) ABSTRACT

A proxy system receives and order instruction that combines multiple components configured for execution at a distributed system of subsystems. The proxy system predicts probable values and probable quantities for assets at which the proxy system is allowed to cause execution of the multiple components at the one or more subsystems. The proxy system creates a virtual proxy instruction that is a proxy for the order instruction and detects optimal conditions of the distributed system, and sends messages to cause execution of the multiple components at the subsystems. The indirect execution through the virtual proxy instruction reduces a message-to-execution ratio compared to direct execution of the multiple components based on the order instruction.

### TECHNICAL FIELD

The disclosed technology relates to processing operations having multiple components in a distributed system.

### BACKGROUND

A computer network is a set of computers sharing resources located on or provided by network nodes. The computers use common communication protocols over digital interconnections to communicate with each other. A computer network extends interpersonal communications by electronic means with various technologies, such as email, instant messaging, online chat, voice and video telephone calls, and video conferencing. A network allows sharing of network and computing resources. Users may access and use resources provided by devices on the network, such as printing a document on a shared network printer or use of a shared storage device. Network congestion in data networking and queueing theory is the reduced quality of service that occurs when a network node or link is carrying more data than it can handle. Typical effects include queueing delay, packet loss or the blocking of new connections. A consequence of congestion is a decrease in network throughput. A flood of messages to a particular resource can be indicative of a cyberattack in which the perpetrator seeks to disrupt services of the resource as a host.

Algorithmic trading (“algo trading”) uses a computer program that follows instructions to change the positions of users as recorded in one or more ledger relative to a representation of a security. A trade typically requires communicating messages between entities over a computer network. In theory, the result of executing such actions depends on the speed and frequency in which the messages are communicated. However, the speed and frequency that messages are communicated increase the risk of network disruptions due to flooding. In one example, a spread trade is the simultaneous purchase or sale of at least one instrument and counterpart of at least one different instrument, each instrument called a leg, as a combined unit. In algo trading, a computer system executes two or more legs by communicating messages over one or more computer networks between entities. Given that spread trades are executed to yield an overall net position whose value, called the spread or spread-level, depends on the difference between the prices of the legs, relative weighting of the legs, or other mathematical relationships, such algo trading can result in computer network disruptions, incomplete execution of all legs, or a unit that does not reflect the desired spread level. Spread trades are executed to attempt to gain from the widening or narrowing of the spread, rather than from movement in the particular value of each of the legs. Hence, spreads are executed depending on whether the trade will gain from the widening or narrowing of the spread.

Some common spreads are priced and traded as a unit on electronic exchanges rather than executed as individual legs, thus ensuring simultaneous execution and eliminating the execution risk of one leg executing while the other leg fails to execute. However, some spreads are not offered as a unit or can only be executed using individual legs because the legs are resident on different exchanges or markets. A user who trades spreads causes one or more computers to execute each leg of the spread manually (e.g., entering each leg order sequentially into a computer when conditions meet a criteria), by an automated execution platform, or by an algorithm-driven execution platform that attempts to execute all of the legs as efficiently and accurately as possible once the conditions are met.

### BRIEF DESCRIPTION OF THE DRAWINGS

Embodiments of the present technology will be described and explained through the use of the accompanying drawings in which:

FIG. 1 is a block diagram of a computer that can employ aspects of the described technology.

FIG. 2 is a block diagram illustrating a simple, yet suitable, system in which aspects of the described technology may operate in a networked computer environment.

FIG. 3 is a schematic diagram of components within various embodiments of the present system.

FIG. 4A is an example flow diagram illustrating aspects of some embodiments of the technology.

FIGS. 4B, 5A and 5B show tables or display screens for representative data that may be generated by various embodiments of the system.

FIGS. 6A, 6B, 6C, 7A, 7B, 7C, 7D, 7E and 7F are examples of various display views of the present technology.

FIGS. 8 and 9 are block diagrams illustrating various components of various system configurations of some embodiments of the present technology.

FIG. 10 illustrates an example of a quick action interface that may be used in accordance with one or more embodiments of the present technology.

FIG. 11 is a block diagram that illustrates components of a proxy system configured to perform aspects of the disclosed technology.

FIG. 12 is a flowchart that illustrates a process performed by a proxy system to execute a spread order in a distributed system.

While the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the invention as defined by the appended claims. Finally, the headings provided herein are for convenience and do not necessarily affect the scope or interpretation of the described technology.

### DETAILED DESCRIPTION

The disclosed technology solves technical problems that arise when attempting to execute a spread order instruction (also referred to herein as a “spread order” or “spread”) having multiple component leg orders for different electronic exchanges. A spread operation can create indexed relationships among the legs that specifies different criteria (e.g., prices, quantities) that should be maintained within tolerable levels. In prior techniques, a message for each leg order is communicated and executed sequentially when market conditions meet specified criteria. That is, orders are serially messaged manually for individual electronic exchanges. However, because conditions are dynamic and volatile, prior techniques require constantly placing, canceling, and/or replacing orders for individual electronic exchanges as prices on the exchanges change. As a result, some legs could execute while other legs fail. Prior improvements include algo-trading platforms that automate manual processes but still suffer from the same inefficiencies and create new inefficiencies. For example, algo-traders cause messaging congestion across networks, as a program places, cancels, and/or replaces thousands of orders in response to volatile conditions to only fill a few orders. The resulting message-to-fill ratio (e.g., number of messages required to execute a fill) is not only inefficient and creates network congestion but can result in the algo-trader being flagged as a malicious actor and denied access to the electronic exchange.

The technology includes a proxy system (“system”) that provides a customer-facing environment intermediary between users and exchanges. The system creates a virtual exchange where orders are processed to create virtual orders that are held to execute at predicted criteria when distributed electronic exchanges satisfy the criteria. Thus, the system ensures simultaneous execution of multiple legs that are resident on different electronic exchanges, as a unit, and eliminates the risk of one leg executing while the other leg fails. Instead of repeatedly placing, canceling, and/or replacing orders, the system maintains virtual spreads in a standardized format and executes when criteria are met across real electronic exchanges. An example of the standardized format includes a decimalized representation of legs from different electronic exchanges. The decimalized representation is dynamic to respond to changes in conditions while providing uniform information to customers.

The system thus provides virtual spread orders at the system as risk proxies as spread orders to be executed at electronic exchanges. The risk proxies use decimalized and other standardized constructs of the virtual spread orders are based on actual data. As such, the system assumes the risk of spread orders and determines an optimal time to place and execute orders for the spread order when legs could be simultaneously executed on individual electronic exchanges. Moreover, the system does not expose legs or leg orders to the individual electronic exchanges, except when criteria are satisfied as specified at the system. As a result, the system is more efficient, reduces messaging congestion, and results in less transaction costs.

The inventors have recognized that current technology lacks an effective method, system, graphical user interface (GUI), and/or device to mitigate the risk of failed execution and mitigate network congestion that arises when attempting to optimize the simultaneous execution of leg orders at electronic exchanges, which are remotely located from each other and connected over one or more communications networks. For instance, given the multiple execution requirements of a spread order operation, a user such as a trader can miss the target value for a criterion (e.g., price) on one of the legs, which can result in a sub-optimal pricing of the overall spread (“slippage”), or not get an order filled on all of the target leg orders (i.e., getting “legged out”), and results in filling a spread that deviates from an desired spread order operation. This can create greater risk and volatility in the resulting position for the user. In such a case, the user can reverse out of all the filled legs (typically at a loss) and start over, manage slippage by executing the missing leg at a different criterion value (e.g., the spread order is filled but not at the target value), attempt to fill a missed leg with a substitute that is likely not as closely correlated to the original target legs, and/or keep the unbalanced position as-is. In all cases the execution risk may result in a trade that is not modeled as part of a strategy.

The disclosed technology can ensure (e.g., guarantee) spread order executions with fills that satisfy specified criteria by transferring some or all of the risk of a multi-legged spread order operation from a user to a different user, another account, a firm, or another entity entirely. The technology can guarantee execution of a spread order operation that satisfies a specified criteria because the technology provides a specific, value of criteria, guaranteed value range, or likely executed value to the user while providing a transfer of risk to the system. However, separate legs of the spread are not executed until the system determines a selected or best time to fill each leg of the spread order. The user's execution risk is thus partially or fully offloaded away from the user and moved to the system. The system provides functionality such as this and functionality which could not be performed manually to satisfy criteria of a spread order operation (or preformed in any commercially valuable way).

The terms “technology” and “system” are occasionally used interchangeably herein, and refer to a “GX2” system as shown in the Figures. While the term “trader” is used generally herein, those of ordinary skill in the relevant art will recognize that any user may employ the present system. Furthermore, some embodiments of the present system are applicable to trading not only, for example commodities, but any instrument capable of being traded on an electronic market.

The term “fills” includes a reported transaction from an electronic exchange, as well as other fills, such as proxy fills performed by the system described in detail herein. While the various embodiments of the present technology are generally described as a user interacting with the system via a GUI (e.g., receiving orders or other data regarding a spread via the GUI), some embodiments of the technology can alternatively or additionally permit any user or external system to access the technology using an application programming interface (API). The technology not only allows multiple clients to access a centralized server configured to execute “risk proxy” operations that assume risk of the clients, but also permits access to the centralized server by other computers (e.g., via APIs).

Some embodiments of the described technology include a system, method, GUI and/or device for executing spread order operations including multiple legs that represent multiple products (e.g., soybean and soybean oil futures), including customized spread relationships. The technology, in accordance with various embodiments, can execute a user specified order including desired spread criteria, which is in balance (e.g., having an intended weighting of one leg compared to the other legs), and not legged out. In some embodiments, the system can compute and present a variety of fulfillment values that may be associated with different value structures. For example, the system can generate a fulfillment value at which the system will likely be able to execute a spread operation for an order but does not guarantee the fulfillment value. The system can also generate a collar for the fulfillment value that limits upside or downside variations in execution. Similarly, the system can generate a guaranteed fulfillment value that shifts all risk to the system, to mitigate variations in the executed orders.

A user client device, with which the user interacts via a GUI, places spread orders using internal risk proxies (e.g., virtual representations of orders). To the user, this appears as a dynamic, real-time display of electronic market data, with which the user can interact to place orders that are immediately fulfilled, even though the actual fulfillment of those orders is possibly done later, and any risk of slippage or others as assumed (partially or fully) by the system.

To increase precision and granularity when calculating values for executing spread orders, one or more risk proxies may associate a decimalized version of an asset with the fractional notation used in the market to represent that asset. These risk proxies are then presented or delivered to the user via the GUI or another electronic means (e.g., an API) so that the virtual environment can be used to determine values in real time or near real time for a user specified or custom-created, multi-legged spreads. As described herein, some embodiments of the technology fill the specified spread orders when values for criteria (e.g., price, liquidity and stability) are satisfied.

When a spread order is executable based on the price level, but the desired quantity is greater than that shown by the system, a partial fill may be generated for the user. Each partial fill of a spread order operation still includes all the legs in the defined ratios of the spread order. For example, an order to acquire a total of 50 of a 3 Year/5 Year treasury spread (buy 50 3 Year contract and sell 30 5 Year contracts) can be partially filled as 25×15 but always in balance including both legs in the 1 to 0.6 ratio. Once an order for a spread is completely filled based on the total specified quantity, the system consolidates risk proxy fills into a single fill using, for example, cash treasuries, Exchange of Futures for Physicals (EFP), and/or Exchange For Futures (EFF), in the case of spreads comprised of those instruments, and always in full accordance with exchange and regulatory rules. The technology can use a multitude of other methods to effect this synthetic risk transfer depending on the markets traded, other users' orders, and synthetic risk proxies can be created to manage this transfer. Additional information relating to these features can be found in the figures.

In some embodiments, the described technology receives spread or portfolio information including a target value between a bid price and an ask price for trading one or more market assets. The described technology can determine a fulfillment value at which to fill a spread or portfolio for the one or more assets, based on the target value, a determined bid price, and a determined ask price specified for the spread order or portfolio at a value substantially equal to the fulfillment value. The fulfillment value is sent to present on a display device for a user. The user who, if specified, the spread at the fulfillment value determined by the system, accepts the spread or portfolio at the fulfillment value. At this point, the risk of execution of the spread can pass from the user to the system, which executes the necessary components of the spread at the best possible price. The system executes the spread or portfolio at the determined bid price and the determined ask price; therefore, there is little to no risk of non-execution of all the legs of the spread or portfolio.

In other cases, any difference between the fulfillment value and the actual executed value can remain with the user. Still yet, in some embodiments, other risk structures can be implemented. For example, the described technology can use a collared risk structure that places a range or collar outside of which the cost difference passes to the system. Additional information relating to these features can be found in the disclosed figures.

The system can administer a platform that supports and provides services to one or more client-side devices each including a display device that presents a GUI configured to display features that allow a user to view, input, create, and otherwise manipulate data to facilitate specifying spreads and other related data (e.g., financial data). The client-side devices communicate with the platform or related server having one or more execution components, risk management components, and client components that generate value (e.g., revenue) primarily by assuming principal risks of spread operations. As used here, principal risk generally relates to transferring, to the system of execution, the gain (e.g., profit) or loss that results from the difference between the guaranteed price value and actual executed price value. Thus, revenue is generated by the system when it ultimately fills the spread better than the guaranteed price or finds efficiencies with other orders it is working from in other requested spreads, or a loss may be incurred if the system cannot execute the spread at a value greater than the value guaranteed to the user.

The platform may be used by the trader to guarantee that the user's execution risk is transferred away from the user and to the system to operate various features of the described technology. For example, an entity (e.g., trading firm and/or other institution) and a user can use the system to analyze markets based on the user's specified spread criteria including a target price.

In one implementation, the system can provide a live, streaming bid price and offer price at which the system can guarantee (or provide a probability of) execution of that spread order operation. Once the user selects a particular value for a criterion of a spread (e.g., a price), the order is filled at the particular value. The execution risk associated with the fill is assumed (partially or fully) by the system, which bundles the legs of the spread, enters the market, and executes the spread at a best possible value, which may be higher or lower than the particular value at which the spread was filled. Thus, the system presents to a user via the GUI (or via an API) a live updating of prices obtained from the electronic exchanges (though modified as noted herein), such that less noticeable delay occurs (e.g., a user can see values and execute orders with delays from actual electronic exchange values that are well under five seconds).

In one implementation, the system quickly customizes an index, portfolio, or spread value based on internal risk proxies. The internal risk proxies can be implemented as a synthetic (e.g., virtual) instrument representing a position that the system inherits at the time of execution risk transfer “ERT”. Users receive fulfillment values while the system receives the opposite side of the operation (in both position and value) of the user's fulfillment values. These synthetic products are then managed and offset by with actual products on the electronic exchanges or inter-dealer brokers.

Spreads, indices, and portfolios are alternate ways of describing a simultaneous execution of a bundle including multiple products (e.g., legs, components, members), and various embodiments may interact with some or all of these products. For example, some embodiments can stream actionable values and sizes in a custom-defined spread. Once the system generates a fill on a ticket for a spread, the system can automatically and algorithmically execute each of the individual instruments that are included in this custom spread as independent legs across one or more electronic exchanges or liquidity pools. The described technology thus allows a user at a client user-interface (and/or API) to quickly select, combine, and weight individual risk proxies to construct custom spreads.

The system can estimate values (e.g., pricing) for multi-legged spreads as decimalized prices for an instrument based on use of internal risk proxy instruments to decimalize and present streaming, actionable events (e.g., at least one ask and one buy for a number of instruments). These risk proxies can be used for internal performance tracking of an entity's users. For example, certain instruments are traded in increments (“ticks”) of a full point (e.g., 1/32, 1/64, or 1/128). The system can convert these values into decimals, which allows for multi-legged spreads to be priced with greater granularity than if only standard tick sizes are used. When the technology is deployed in a trading firm with a common account ownership, for example, these risk proxies may be used as internal accounting entries to track a user's performance. The firm can manage the underlying position of instruments that are executed on the external electronic exchange, but the firm has the ability to account for each user's individual performance while consolidating overall order flow at the entity level or at a pre-determined grouping within or outside the entity.

Various embodiments can provide particular values for criteria for each of the instruments that are included in a specified spread. These values can be used to provide (guaranteed) levels to the user. In order to produce values for prices, the system uses risk proxies to adjust values to levels different than those in the underlying instruments in the electronic exchanges. The system classifies the underlying sources of market data into various states such as stable, stable but not satisfying a minimum quoted quantity, and unstable. These states, along with the underlying price levels are used to estimate prices that are quoted in the risk proxy prices (as defined herein). Each update in price or in liquidity in the underlying instrument is used to evaluate the latest quote in the risk proxies, described herein. The system can access all working spread orders within the system and can use the decimalized values for individual legs as represented by the risk proxies in order to make decisions on when to generate a fill for each spread order.

Embodiments of the described technology can mitigate risks associated with prohibited transactions such as wash sales, which can occur when the same beneficial owner of an account places buy and sell orders for the same instrument at or about the same time and at the same price without the intent to expose the position to market risk. For certain entities, including proprietary trading firms and platforms, the appearance of prohibited transactions can occur when different users within respective entities place buy or sell orders in the same instrument even though the users have no knowledge of each other's orders nor the lack of intent to expose the position to risk.

Electronic exchanges can scrutinize such prohibited activity, however, and the “intent” component of a violation, among other components of this violation, creates uncertainty that is difficult to prove or disprove. In some embodiments, the described technology can determine a single point of execution per traded instrument for an entire firm or omnibus account. This consolidates the interests of competing entity algorithms and entity inventory for optimal execution and risk management, and only sends to the exchanges the orders needed to complete the net orders of the entity instead of sending multiple orders from different users within an entity.

Various embodiments of the technology will now be described. The following description provides specific details for a thorough understanding and enabling description of these embodiments. One skilled in the art will understand, however, that the described technology may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this Detailed Description section.

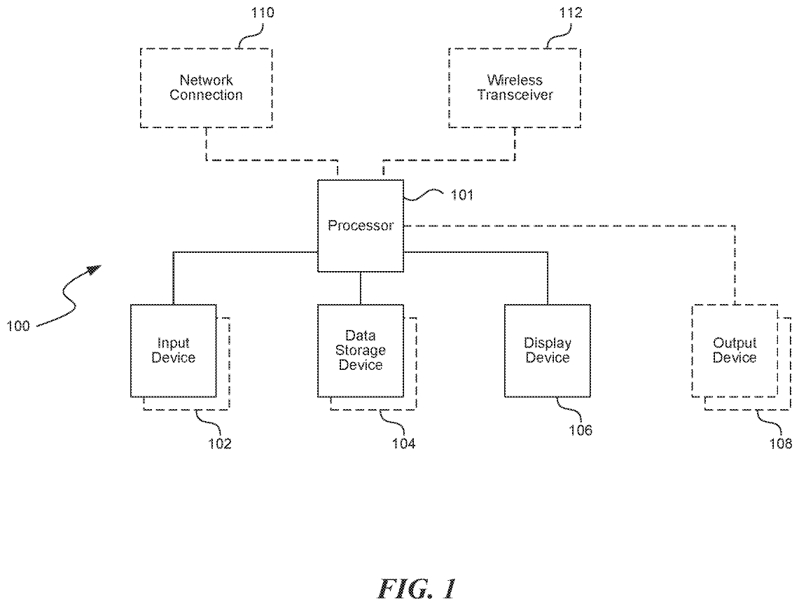

FIG. 1 and the following discussion provide a brief, general description of a suitable computing environment in which aspects of the described technology can be implemented. Aspects of the technology are described herein in the context of computer-executable instructions, such as routines executed by a general or special purpose data processing device (e.g., a server or client computer). Aspects of the technology described herein may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data related to the technology may be distributed over the Internet or over other networks (including wireless networks) on a propagated signal on a propagation medium (e.g., an electromagnetic wave(s), a sound wave, etc.) over a period of time. In some implementations, the data may be provided on any analog or digital network (packet switched, circuit switched, or other scheme).

The described technology can also be practiced in distributed computing environments, where tasks or components are performed by remote processing devices, which are linked through a communications network, such as a Local Area Network (“LAN”), Wide Area Network (“WAN”), or the Internet. In a distributed computing environment, program components or sub-routines may be located in both local and remote memory storage devices. Those skilled in the relevant art will recognize that portions of the described technology may reside on a server computer, while corresponding portions reside on a client computer. Data structures and transmission of data particular to aspects of the technology are also encompassed within the scope of the described technology.

Referring to FIG. 1, in some embodiments, the described technology employs a computer 100, such as a personal computer, workstation, tablet, or smart phone, having one or more processors 101 coupled to one or more user input devices 102 and data storage devices 104. The computer is also coupled to at least one output device, such as a display device 106 and one or more optional additional output devices 108 (e.g., printer, plotter, speakers, tactile or olfactory output devices). The computer may be coupled to external computers, such as via an optional network connection 110, a wireless transceiver 112, or both.

The input devices 102 may include a keyboard, keypad, touch screen, and or a pointing device, such as a mouse. Other input devices are possible, such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network, such as a local area network (LAN), wide area network (WAN), or the Internet (not shown in FIG. 1).

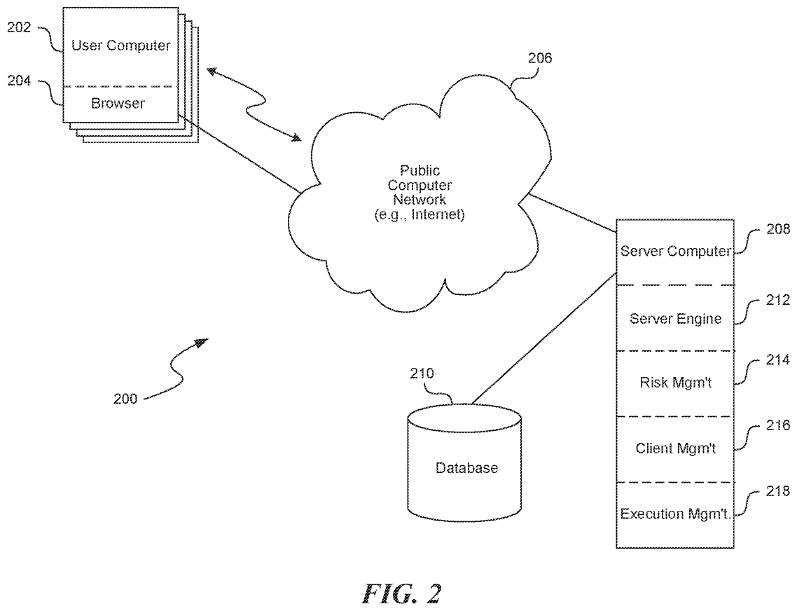

Aspects of the described technology may be practiced in a variety of other computing environments. For example, referring to FIG. 2, a distributed computing environment with a web interface includes one or more user computers 202 (e.g., mobile devices) in a system 200, each of which includes a browser program component (e.g., a thin client component) 204 that permits the computer to access and exchange data with the resources, including servers, trading firms, electronic exchanges, market data platforms, and or web sites within a LAN or the World Wide Web portion of the Internet. The user computers 202 may be substantially similar to the computer described above with respect to FIG. 1. User computers 202 may be personal computers (PCs) or mobile devices, such as laptops, mobile phones or tablets. The user computers 202 may connect to the Internet 206 wirelessly or through the use of a wired connection. Wireless connectivity may include any form of wireless technology, such as a radio access technology used in 2G/3G/4G/5G/6G or other mobile standards.

User computers 202 may include one or more client-side software components (e.g., software, a GUI, and or hardware) to facilitate trades and other data transactions with at least one or more of the various services mentioned above. User computers 202 may include other program components, such as an operating system, one or more application programs (e.g., word processing, spread sheet applications, or Internet-enabled applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here. For example, a mobile application or “App” has been contemplated, such as one used in Apple® iPhone® or iPad® products, Microsoft® products, Nokia, or one used in Android®-based products.

At least one server computer 208, coupled to the wired and or wireless LAN, WAN, Internet, or World Wide Web (“Web”) 206, performs some or all of the functions for receiving, routing and storing of electronic messages, such as electronic trades, communications, financial data, alerts, web pages, audio signals, and electronic images. While the Internet is shown, a private network, such as an intranet, may indeed be preferred in some applications. The network may have a client-server architecture, in which a computer is dedicated to serving other client computers, or it may have other architectures, such as a peer-to-peer, in which one or more computers serve simultaneously as servers and clients.

A database 210 or databases, coupled to the server computer(s), stores many of the web pages and content exchanged between the user computers. The server computer(s), including the database(s), may employ security measures to inhibit malicious attacks on the system and to preserve integrity of the messages and data stored therein (e.g., firewall systems, secure socket layers (SSL), password protection schemes, encryption, and the like).

The server computer 208 may include a server engine 212, a risk management component 214, a client management component 216, and an execution management component 218. The server engine 212 performs basic processing and operating system level tasks. The risk management component 214 handles creation of electronic trades, risk calculations, and or determinations and other features included in the various embodiments therein. Users can access the server computer by means of one or more network protocols (not shown), such as TCP/IP associated therewith. The client management component 216 handles most of the functions sent to and received from the trader and various embodiments described herein. The execution management component 218 includes storage, retrieval, and execution tasks that, alone or in combination, determine, for example, pricing values, spread level fill data, proxy data, etc. In some embodiments, multiple server computers 208, each having one or more of the components 212-218, may be utilized.

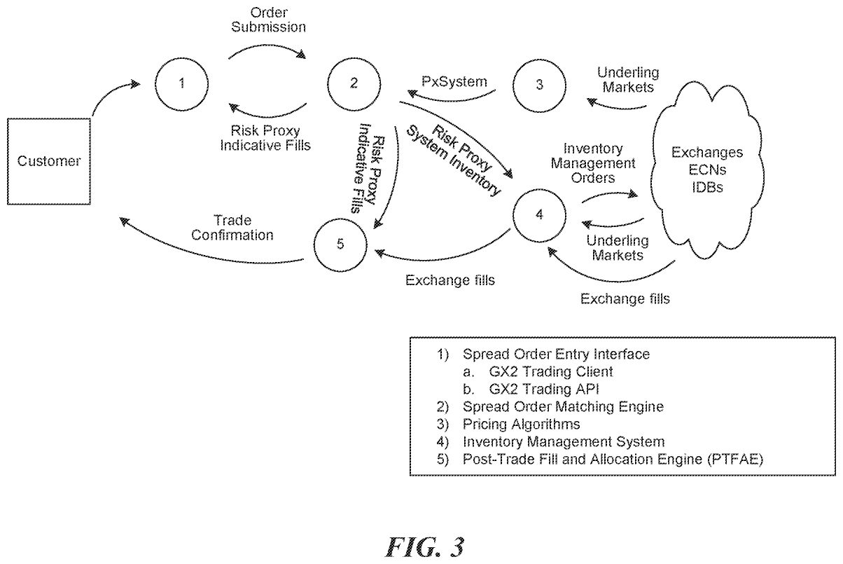

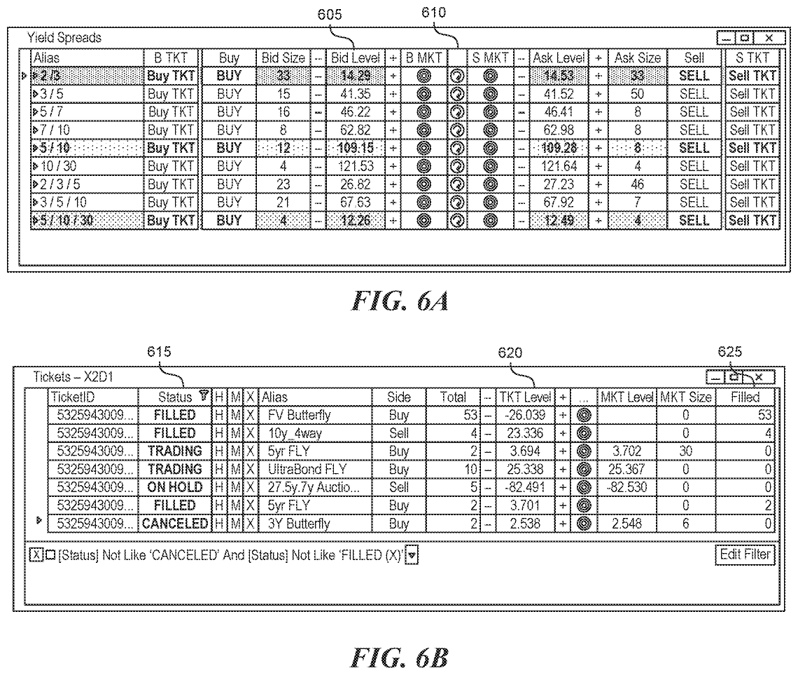

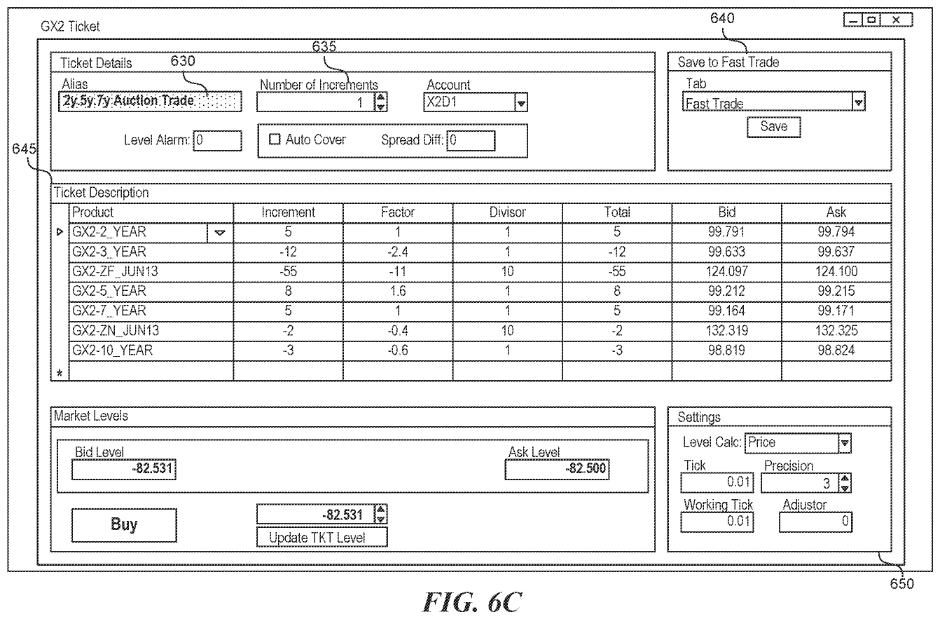

Referring to FIG. 3, a set of components that may be used in accordance with various embodiments of the present system are shown. As shown, the system includes a Spread Order Entry Interface (1) (see, e.g., FIG. 6C) that includes the Trading Client and Trading API described herein. The system can also include a Spread Order Matching Engine (2), Pricing Algorithms (3), and an Inventory Management System (4). Furthermore, the system includes an Exchange for Physical (EFP) Trade Confirmation and Position Delivery Engine (5) or other trade confirmation engine for other instruments. An example of the system including at least some of these components is illustrated in FIG. 11.

Spread orders are defined (and optionally saved to a workspace) by the trader and submitted using the Spread Order Entry Interface (1), which is shown and described in greater detail in the figures. Upon submission by the trader, spread orders, in some embodiments, are held at an electronic central limit book (explained below), which is accessible to the Spread Order Matching Engine (2). The Spread Order Matching Engine (2) can evaluate when electronic spread data structures or tickets will be executed based on prices and sizes/amounts generated by the Pricing Algorithms (3), as described below. Once all of the legs of a spread order can be fulfilled according to the Pricing Algorithms (3), the Spread Order Matching Engine (2) generates an indicative fill for the trader using the risk proxies and issues a change in inventory instruction to the Inventory Management Algorithms (4). The indicative fill may be a data structure and/or message for a trader to indicate that the spread has been filled, even though the actual electronic order has yet to occur.

In general, the system may employ a spread level calculation for a typical spread, such as:

SPREAD PRICE=PRICE_LEG1*(FACTOR1/DIV1)+PRICE_LEG2*(FACTOR2/DIV2)+PRICE_LEG3*(FACTOR3/DIV3)+ . . .

Where:
PRICE_LEG$=the price of the risk proxy that is produced by the system
FACTOR$=represents the trading ratio between LEG1 and LEG$
DIV$=a divisor used to equate the different notional amounts, point values, native currencies, etc.

Risk proxies may be used by the system to represent accounting entries that can be used by a firm for performance tracking of its users or portfolio managers. Risk proxies are used by the system to represent a price and quantity available to fulfill the included legs of a spread order. When a spread order is fulfilled, the trader receives an indication of a fill when the system provides or delivers to the user a risk proxy price and quantity. Simultaneously the system receives notification of an opposing position in the risk proxies. This notification identifies a change in inventory for the system. The system issues an instruction triggered by this change in inventory under the Inventory Management System (4).

The Inventory Management System (4) can manage the orders and prices posted on the exchange in the underlying instruments to reduce the system inventory to a desirable position. The desired position of the system may be that of zero position or the desired position of the system may be to maintain a stable position that includes correlated or co-integrated members of a portfolio. The desired position is not a unique solution and can vary from one system implementation to another.

Post-Trade Fill and Allocation Engine

The indicative fills are converted to positions in exchange traded products using the EFP Trade Confirmation and Position Delivery Engine (5). Thus, after the user receives indication that the spread has been filled, the EFP Trade Confirmation and Position Delivery Engine (5) actually executes each leg of the spread on one or more electronic markets. Note that EFP is not used in every type of spread execution by the system or in every type of implementation of the present technology. For example, one implementation may not require EFP because the system is deployed within a proprietary firm with common account ownership, but if a firm had external customers it would typically employ the EFP process on certain instruments to deliver the fills.

In a broker dealer system implementation (see, e.g., FIG. 9), the system may use EFP's to deliver fills to customers when a futures leg is included in a spread definition. The system may use a “Give-Up” of the exchange executed futures to the customer of a Broker Dealer, which could reduce overall execution costs and expand the set of possible spreads that could be defined in the system (e.g., futures versus futures spreads). A give-up can refer to a procedure where an executing trader/broker places a trade on behalf of another trader/broker as if he or she actually executed the trade, and the trade is not actually recorded as being executed by the executing trader/broker. In accordance with various embodiments, any regulatory-compliant method may be utilized by the system to efficiently deliver fills.

Predictive Pricing Engine (PPE)

Detailed descriptions of certain components can help provide a further understanding of aspects of the system. The pricing algorithms (3) draw together information from the underlying exchange-traded or inter-dealer broker markets to decimalize, tighten, and appropriately size the liquidity presented to fulfill the guaranteed spread levels to traders using the disclosed system. The pricing algorithms form a fair market decimalized price for each instrument that may be traded in the system. This market (e.g., a fair market) may be based on an inverse liquidity weighting using, for example, the following formulation:

P_{fm}=(S_{b}*Pₐ+Sₐ*P_{b})/(S_{b}+Sₐ)
Where:
P_{fm}—Fair Market Price
Pₐ—Ask Price in the underlying market
P_{b}—Bid Price in the underlying market
Sₐ—Ask Quantity in the underlying market
S_{b}—Bid Quantity in the underlying market
P_{bsystem}—Bid Price of the system
P_{asystem}—Ask Price of the system
S_{asystem}—Ask Quantity of the system
S_{bsystem}—Bid Quantity of the system
Sₐₘₐₓ—Maximum Ask Quantity of the system
S_{bmax}—Maximum Bid Quantity of the system
ϕ—liquidity factor, defined as a percentage of the liquidity in the underlying market instrument. For example, a 10 Year cash treasury may show liquidity as 38 mm (million) on the top of book best bid. A liquidity factor equal to 75 would imply a quote in the risk proxy of 28 mm liquidity on the indicative best bid level.

Once the system calculates P_{fm}, it can generate an effective system bid and ask price as well as a system bid and ask quantity. Factors that the system can consider to derive these system bid/ask prices and quantities include:
Fixed decimalized price spread from the P_{fm}
Fixed limits for P_{bsystem} and P_{asystem} in relation to the underlying market P_{b} and Pₐ

For example, a Quote 1 for instrument X

| bid qty | bid price | ask price | ask qty |
|---|---|---|---|
| 100 | 99.15 | 99.16 | 100 |

Quote 2 for instrument X

| bid qty | bid price | ask price | ask qty |
|---|---|---|---|
| 100 | 99.12 | 99.19 | 100 |

In the example above, both markets have the same Fair Market Price of 99.155. The spread from P_{fm} would provide the same quote in the risk proxies. Only the Fixed limits for P_{bsystem} and P_{asystem} would widen the market in the risk proxies in the second underlying market quote. If the fixed limit were set to 0.015, the market in the risk proxy would be 99.135 bid 99.175.

The system can apply the above algorithm to account for three different states for each leg of a spread: stable, stable but does not meet minimum quoted size in the underlying market, and unstable. Based on the particular application or trading philosophies of a firm, the variables of the algorithm may be modified as desired to account for the three different states. For example, the difference between stable and unstable may be the length of time the price remains stable for a particular product. In general, unstable represents a moving price for one or more legs in the spread. To price individual risk proxies, the system looks at the state, the bid and ask prices and liquidity for each leg. More specifically, the system may consider:
The stability or volatility of price changes. The system may impose a hysteresis on price changes in the direction of the market that ends once price stability is established.
System quantities (S_{asystem} and S_{bsystem}) are calculated based on the underlying market quantities. These quantities are calculated using the following formulation.

S_{asystem}=min(floor(ϕ*Sₐ),Sₐₘₐₓ)
System inventory is also taken into account for the system quantity. For example, S_{asystem} is decreased and S_{bsystem} is increased when the system holds a short position in the underlying instrument.
The system can quote a guaranteed minimum size by looking to the depth of the market to calculate both system price and quantity. If floor (ϕ*<1, a zero quantity would be quoted. This secondary quantity algorithm examines the prices and quantities available away from the best bid or offer (BBO) to generate a defined Sₐₘᵢₙ.

Simultaneous Execution Matching Engine (SEME) and Inventory Management System (IMS)

Fulfilling users' spread orders generates system inventory (i.e., some position held by the system's account in the traded instruments). This inventory is managed by the Inventory Management System (4) and can be located on computers at the closest possible proximity to the exchange the underlying instrument is trading on (e.g., for optimal execution, processes or algorithms described herein can reside on a computer co-located at an exchange matching engine to minimize latency). An exchange co-location is usually preferred when available. The Inventory Management System (4) are triggered to bring the position of the system to a desirable level (e.g., a best price). Factors that affect the decision to trigger an Inventory Management System can include:
Instruments are treated individually and the best execution decision is made without regard to other positions held by the system.
Ratio between the available liquidity on the bid and the ask of the underlying instrument.
Ratio of the size of the system inventory and the available liquidity on the opposite side of the market of the underlying instrument.
Pricing consideration that keep prices of orders equal to the prices on the top of the book best bid or offer (BBO). In other words, the orders for the system are placed at the most competitive prices in the market. If the market moves away from these prices, orders are adjusted to the new prevailing best bid or offer BBO.
Current values and dynamics of market variables are used to control aggressiveness of the inventory management algorithms.
Extensions to inventory management include evaluating the system inventory and making adjustments to the most stable overall portfolio in order to increase the holding time of positions.

In general, the system attempts to execute the spread at the “best” possible price. Determining the best possible price can take into account one or more of the above-noted factors. The best price typically is an optimal price as defined by one or more inventory management algorithms. The Inventory Management System (4) can take into account both price and liquidity for each product bought/sold. The Inventory Management System (4) may not consider time or price relative to the entry time or price of the legs when entering the market.

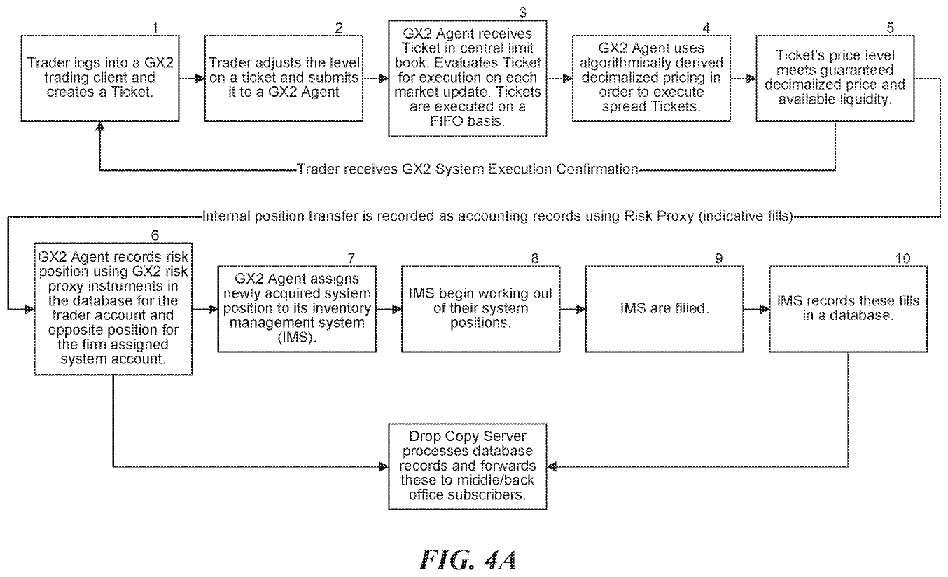

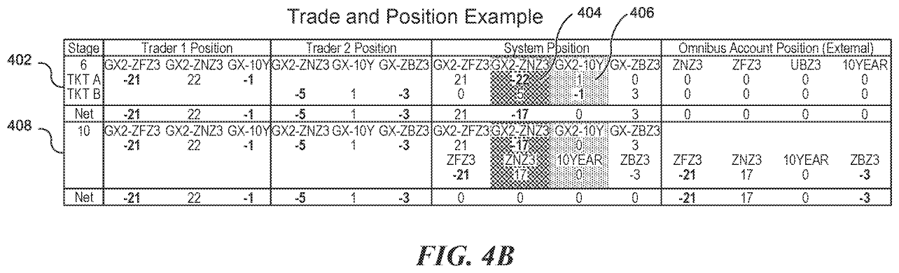

An example of a suitable system trade flow is shown in FIG. 4A. The flow begins in block 1 where a trader logs into a trading client residing on a computer associated with the trader (or an associated API logs in) and creates a ticket, which represents the desired spread created by the trader. At block 2, the trader can adjust the ticket level (e.g., by increasing or decreasing a price that the trader is willing to bid/sell an instrument and/or the quantity of the spread desired) (see, e.g., FIG. 6C) and submit the ticket to a Spread Order Matching Engine.

At block 3, an entry for each ticket is recorded in an electronic central limit book, which is a repository that stores received tickets in a format from, for example, the highest bid ticket down to the lowest order ticket. With each update to the market, the Spread Order Matching Engine and/or other components, evaluates tickets in the central limit book for execution upon each market update.

At block 4, the Pricing Algorithms, and/or other features/components, use algorithmically derived decimalized pricing in order to execute spread tickets. For example and as explained above, to increase precision and granularity when calculating spreads, a decimalized version of an instrument is associated with the fraction used in the market to represent that instrument.

At block 5, when the Pricing Algorithms, and/or other features/components, determine that the ticket price level meets a guaranteed decimalized price and available liquidity, the trader is sent a confirmation that his/her ticket is fulfilled.

At block 6, the Inventory Management System, or other feature/component, accounts for internal risk by recording (e.g., in a database) the position entry for the trader and an opposite position entry for the firm assigned system account.

At block 7, Inventory Management System, or other features/components, use the newly acquired trade positions in its execution processes so that, at block 8, one or more new execution processes can be developed and executed, at block 9, to fulfill a market order for the internal system. At block 10 the market order fills are recorded in a database. Database records, from block 6 and block 10, in some embodiments, are made available to other components/market entities (e.g., middle/back office subscribers) for accounting and other purposes.

Note that the system may not execute all or any of the spread legs in the market, particularly if it has opposing orders by other users and can just net them out. An example of this is shown in FIG. 4B, where Trader A creates a spread associated with Ticket A, while Trader B creates Ticket B, shown in the first row 402. These tickets are created or recorded under block 6 of FIG. 4A (as represented in the column “Stage”). In the example shown, Trader A shorts future ZF at −21 and 10Y cash at −1, but buys ZN at 22. Trader 2 executes the second position represented by Ticket B concurrently as shown. Note that each of these products are shown with a prefix “GX2”, which represents an internal dissemination or data structure used by the system. (The suffix “Z3”, for example, refers to expiration code for the product.)

As shown in the System Position column, the system determines a net position, in this example, between Ticket A and Ticket B. With respect to the security ZN shown in column 404, the −22 for Trader 1 combines with the 5 for Trader 2 for a net −17 that the system must execute with actual exchange traded contracts. But for the 10Y, the −1 for Trader 1 and 1 for Trader 2 net to 0 as shown in column 406, and thus the system need not make any actual trade on the electronic market. The system mitigates any perception of a wash sale by aggregating these internal trades as noted herein.

Post-Trade Fill and Allocation Engine (PTFAE)

As shown in the Omnibus Account Position (External) column, the system shows that the system achieves a desired position (zero position) for the position of all traders in row 402. Note that the System Position reflects the opposite position taken by the system after aggregating all of the tickets from the different traders (which in this simple case was only 2). Thus, as shown in row 408, the system converts the internal commodity GX2-ZNZ3 at −17 to an actual commodity ZNZ3 at 17, which represents an actual trade on the electronic market of purchasing the commodity ZNZ3 at 17, where the actual purchase is shown in row 408 in the Omnibus Account Position (External) column.

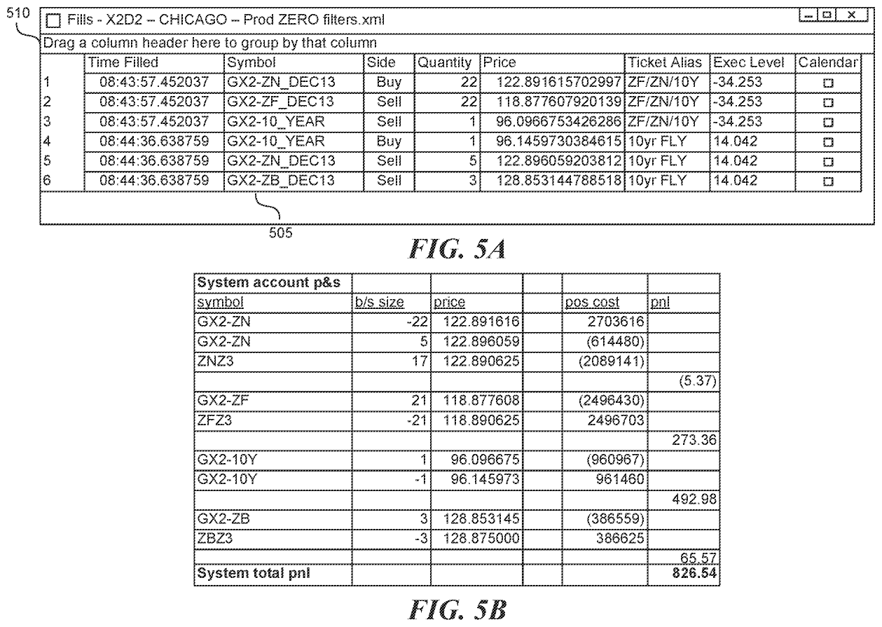

FIG. 5A shows an example of a GUI or API employed by the system to represent each Trader's transaction and shows fills as “guaranteed” by the system for the example of FIG. 4B. In accordance with some embodiments, a trader can drag a symbol heading in symbol column 505 to the group by box 510 which will cause the orders to be rearranged so that all fills are grouped by symbol. This allows the user to see the net position for all filled products as well as the average fill price and the average executed level. FIG. 5B shows an example of a screen or data structure representing the system executing the spreads for the two Traders via the actual exchange traded contracts and the resulting gain and loss (pnl). In the example, the system lost 5.37 on the ZNZ3 leg, but earned 492.98 on the 10Y.

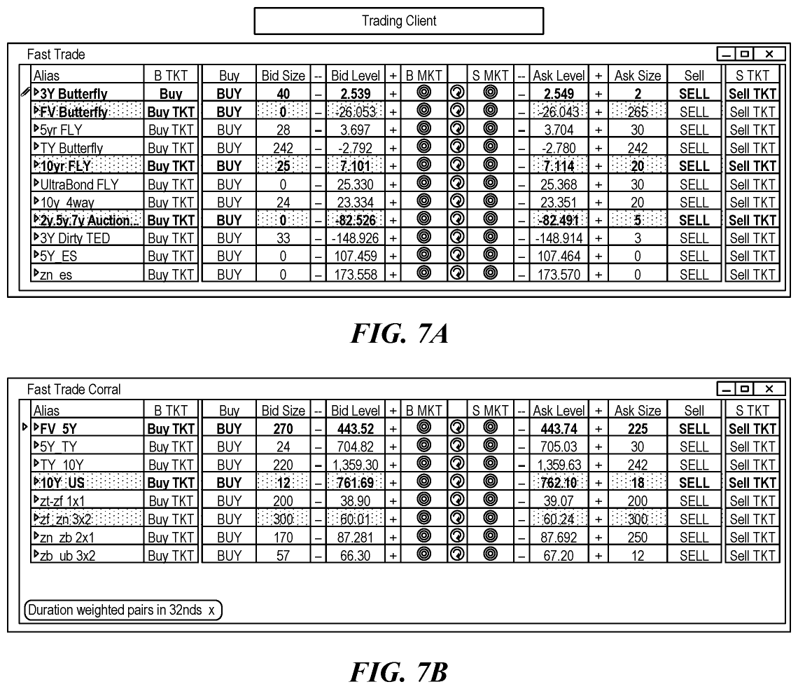

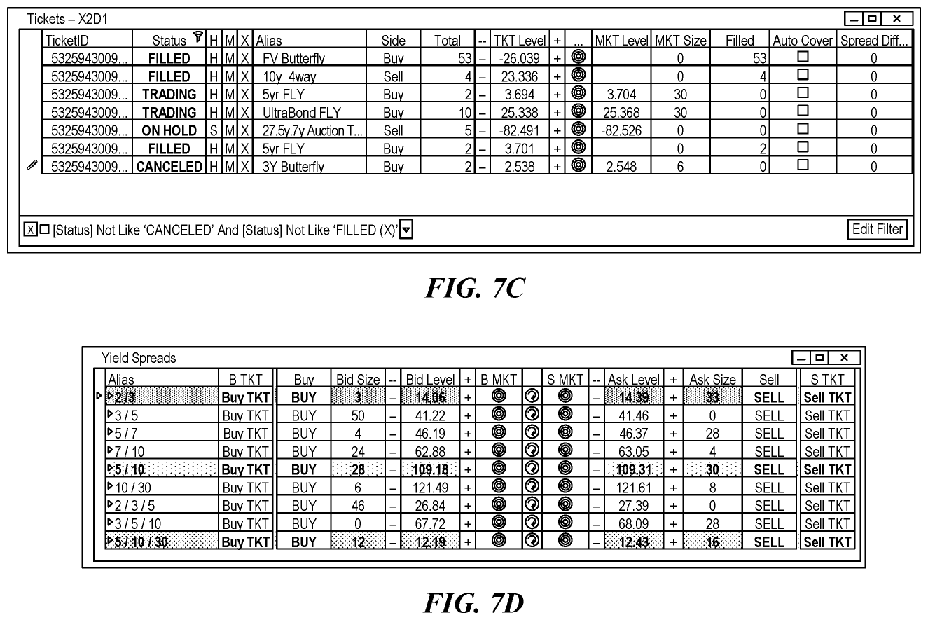

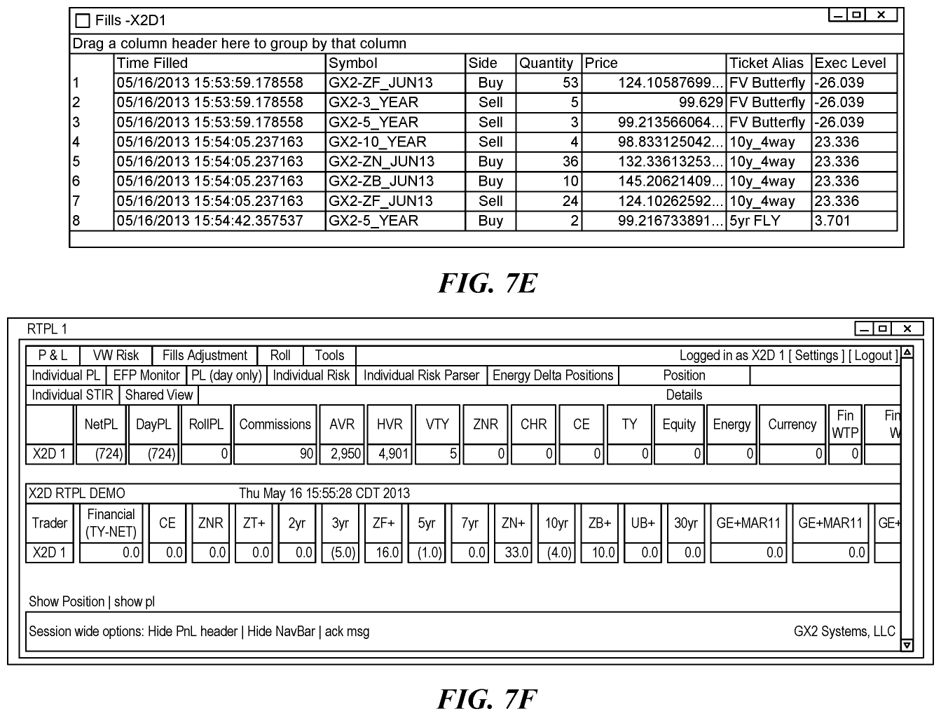

FIGS. 6A-6C and 7A-7F are examples of various displays that may be used by one or more embodiments of the present technology. For example, FIG. 6A illustrates a fast trade window of customized strategies that can be set by a trader and a limit order book for managing strategy execution. These trading strategies can be set and then quickly executed by selecting the buy TKT or sell TKT buttons. Similarly, the trader can buy or sell individual lots. Before submitting spread orders, the bid level column entries 605 can be edited to allow a user to modify bid levels. The buttons in column 610 can allow the user to reset the bid and ask level to the current market levels.

FIG. 6B illustrates a display screen with a limit order book for managing strategy execution. This display screen allows the trader to see the status of submitted order tickets, working ticket levels, and filled quantities. Status column 615 shows the current status (e.g., on hold, trading, canceled, filled, etc.) of the ticket. Ticket level column 620 shows the working ticket level and filled column 625 shows the filled quantity of the first leg. In some embodiments, additional columns may be present that allow the user to select the autocover functionality. When the autocover functionality is active, for each primary filled spread ticket the user receives, a closing or covering spread is placed automatically. This covering ticket is placed at a user defined price distance away from the primary filled spread ticket.

If autocover is engaged, an identical ticket of the opposite side will be submitted when the initial ticket is filled. The level of the “Cover” ticket is the determined by the Ticket Level Diff set on the initial ticket (e.g., if you're working a buy ticket at the level 100.00 with autocover engaged and a Ticket Level Diff of 1.00, when the buy ticket is filled a Sell ticket will be submitted at the level 101.) This process will continue until the user disables the autocover feature (e.g., by unchecking an AutoCover box) on the working ticket.

FIG. 6C illustrates an example of a display screen that may be used to enter order tickets for multi-legged strategies that can be created by the trader. As illustrated in FIG. 6C, alias component 630 can be used by the trader to enter a nickname that will make finding the ticket easy for the trader. Increment component 635 allows the trader to select the number of individual increments to be filled. Fast trade component 640 can allow the user to save the ticket to a fast trade screen (e.g., FIG. 6A) within the trading interface.

As illustrated in FIG. 6C, ticket description component 645 can include a table or other interface that allows the user to create the multi-legged trading strategy. Calculation component 650 allows the trader to select the level of calculation. FIGS. 7A-7F illustrate other variations of the trading interfaces once the customized spread orders have been created. In accordance with various embodiments, the system allows a trader to use a variety of features and orders types using these and other graphical user interfaces.

One example of an order type that can be created in some embodiments is the one cancels other (OCO) order. In an OCO order, any ticket that is filled in a group will cancel the other tickets in the group. In some embodiments, a user can select (e.g., right-click) rows on a graphical user interface to assign tickets to an OCO group. Tickets that are not completely filled or canceled can be put in OCO groups. A ticket can belong to only one OCO group at a time. To add a group of tickets to an OCO group, a user can select the tickets in the Spread Tickets window (e.g., use ctrl+click to select a discontinuous set or shift+click to select a continuous set) then right click and select “Add selected tickets to new OCO group”. If one of the tickets selected already belongs to an OCO group the trader may be presented with the option of adding all the selected tickets to that OCO group or to add them all to a new group. Tickets can also be put into OCO groups via the ticket entry dialog by modifying the ticket and then changing the OCO Group ID dropdown.

Another example of an order ticket that the system allows the user to create is the Stop Limit Ticket. The stop limit ticket will be triggered at the Stop Trigger Level and become a limit ticket at the Limit Level specified. The Limit Level Diff allows the user to use the up/down arrows to adjust the level and maintain the difference between the Stop Trigger Level and the Limit Level. Max Spread is the maximum difference between the market bid ask allowed to trigger the stop. For example, in the event of an economic number where markets may widen temporarily, the stop will not trigger if the bid ask spread is larger than the amount indicated in the Max Spread field. Setting the field to blank or “Infinity” may disable this feature in some embodiments.

OCO Stop Limit can be enabled using the graphical user interfaces (e.g., by checking an OCO Stop Limit box). Enabling this feature will create a Stop Limit cover ticket as well as the Limit cover ticket mentioned above. The Stop limit ticket can have a trigger level determined by execution level of the initial ticket+/−(depending on side) the Stop Trigger Level Diff specified. The limit level of the ticket can be the stop trigger level+/−the Limit Level Diff. Finally, the Stop Limit ticket may have the Max Spread value specified in the Max Spread field.

In some embodiments, the graphical user interface screen may present the guaranteed market prices for the spread order along with the prices that are available through the markets where the user would take the execution risk. The user can then evaluate the cost difference and determine whether that difference is worth the elimination (or mitigation) of the execution risk. In some embodiments, the user may be able to set automated trading strategies that automatically select between the guaranteed market prices and the prices that are available through the markets where the user would take the execution risk.

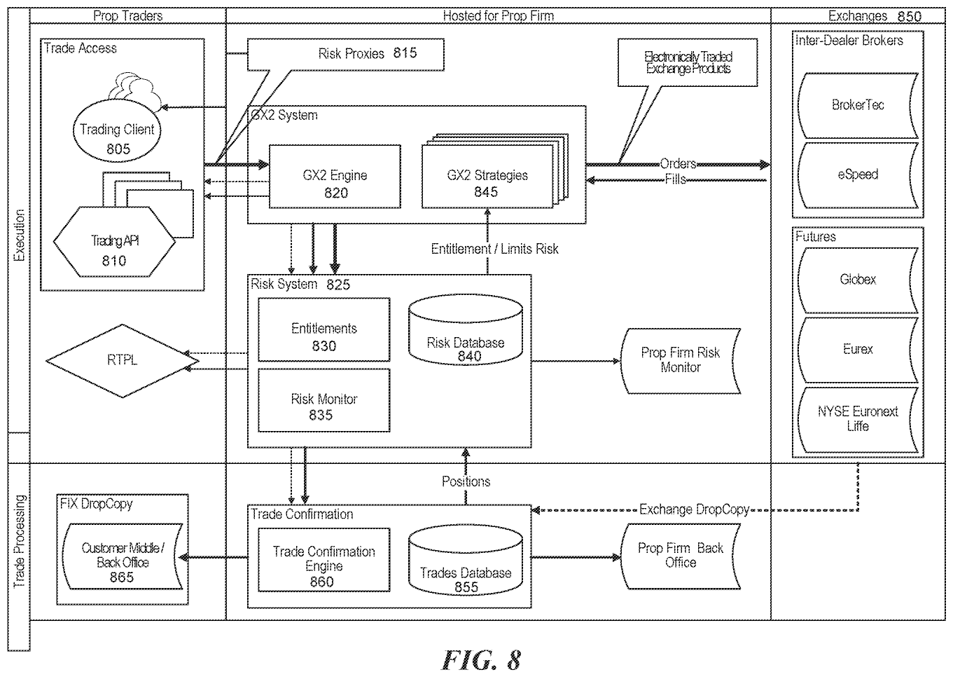

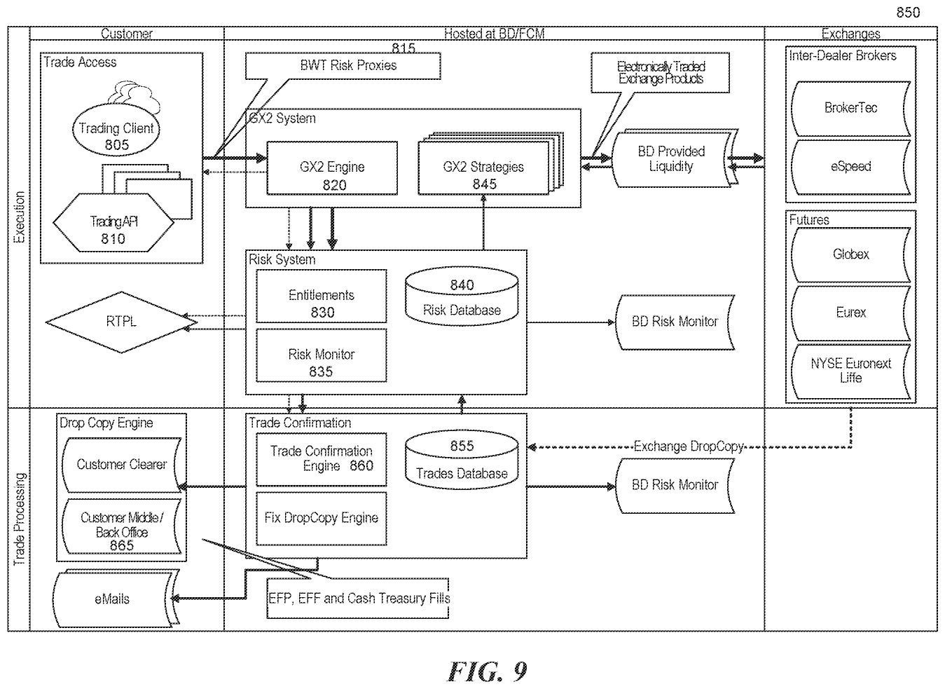

FIGS. 8-9 are block diagrams illustrating various components of various system configurations of some embodiments of the present technology. As illustrated in FIGS. 8 and 9, trading client 805 or trading API 810 can be used to generate spread orders. In accordance with various embodiments, trading client 805 can reside on a computer associated with the trader or may be a thin client that is accessed via a website. The spread orders are translated into risk proxies 815 and are transmitted to system engine 820.

Risk proxies 815 are then submitted to risk system 825 which can use entitlements module 830, risk monitor, 835, and risk database 840 to communicate limits on the spread order. Based on the input from risk system 825, the pricing strategies engine uses algorithmically derived decimalized pricing in order to generate a fulfillment value at which the spread order may be executed. The decimalized pricing can have a granularity greater than those of the underlying market. The information can be transmitted back to trading client 805 or trading API 810 and displayed to the trader. Once the trader accepts the fulfillment value, a spread ticket is created and transmitted back to system engine 820 to execute the spread order using trading strategies 845 on one or more exchanges 850. The trades are stored in trade database 855 and trade confirmation engine 860 generates a trade confirmation that can be transmitted back to other components/market entities (e.g., middle/back office subscribers 865) for accounting and other purposes.

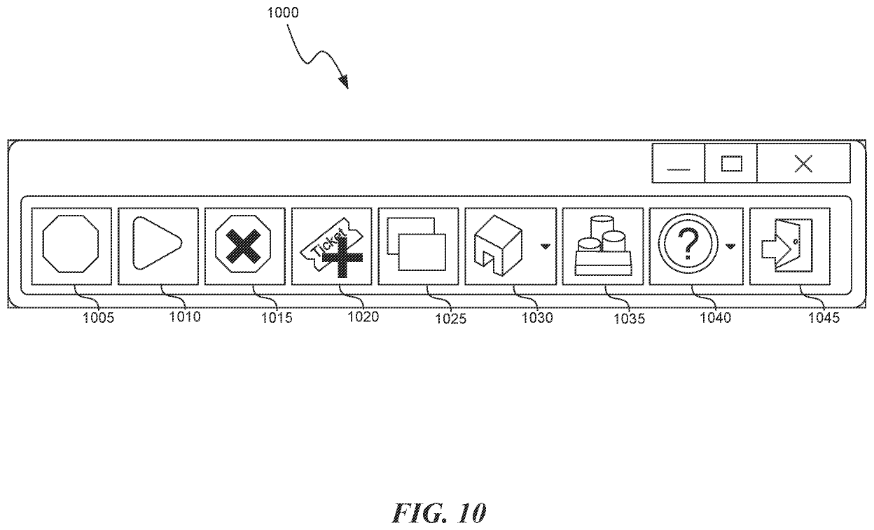

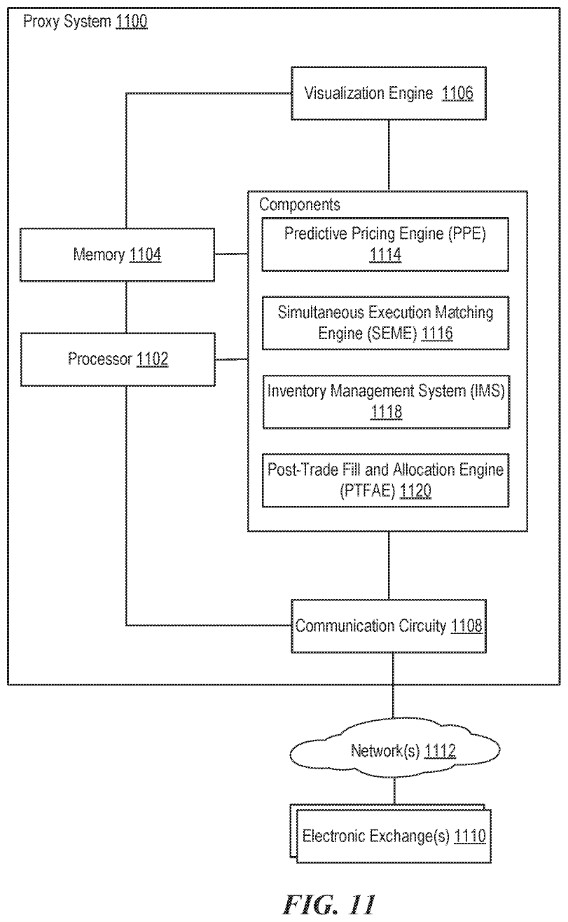

FIG. 10 illustrates an example of a quick action interface 1000 that may be used in accordance with one or more embodiments of the present technology. As illustrated in FIG. 10, stop all button 1005 may be used to place all current working tickets on hold. Start all button 1010 may be used to start all working tickets that are on hold. Cancel all button 1015 may be used to cancel all working and held tickets in a ticket window. New ticket button 1020 may be used to open up a blank ticket template for creating a new ticket.

Fast trade window manager button 1025 may be used to create and manage multiple fast trade windows. Workspace menu button 1030 may be used to open and save workspaces as well as select multiple themes, save and open snap-shot views, and roll instruments. To roll an instrument is to change one or more legs of an existing spread ticket in order to replace an expiring future contract from one that is expires farther out in the expiration schedule. For example, if a trader owns December 14 heating oil and it is going to expire, the system can “roll” it into January 15 heating oil to maintain the trader's position. RTPL button 1035 may be used to open real-time profit and loss (pnl) windows. Help button 1040 may link to various system documentation and help interfaces. Exit button 1045 may be use to close the application.

FIG. 11 is a block diagram that illustrates an example of a proxy system (“system”) configured to perform aspects of the disclosed technology. The components shown in FIG. 11 are merely illustrative and other components are omitted for brevity. As shown, the proxy system 1100 (“system 1100”) includes a processor 1102, a memory 1104, and a visualization engine 1106. The system 1100 can include communication circuitry 1108 designed to establish communication channels with one or more electronic exchanges 1110, over one or more networks 1112. The processor 1102 can have characteristics similar to general-purpose processors or can be an application-specific integrated circuit (ASIC) that provides arithmetic and control functions to the system 1100. While not shown, the processor 1102 can include a dedicated cache memory. The processor 1102 can be coupled to all components of the computing device 1100, either directly or indirectly, for data communication.

The memory 1104 can include any suitable type of storage device including, for example, a static random-access memory (SRAM), dynamic random-access memory (DRAM), electrically erasable programmable read-only memory (EEPROM), flash memory, latches, and/or registers. In addition to storing instructions which can be executed by the processor 1102, the memory 1104 can also store data generated by the processor 1102 (e.g., when executing modules of the system 1100). The memory 1104 is merely an abstract representation of a storage environment. Hence, in some embodiments, the memory 1104 is comprised of one or more actual memory chips or modules.

The visualization engine 1106 can administer a GUI for display on a display device connected to the system 1100. The system 1100 is also connected to an input device (not shown). An example of the communication circuitry 1108 forms and/or communicate with the network(s) 1112 for data exchanges with the electronic exchanges 1110. The network(s) 1112 can include a higher-level network (e.g., a LAN) or the Internet. For convenience, the components may be referred to as modules including computer programs that resides on the memory 1104. The term “module” refers broadly to software components, firmware components, and/or hardware components. Accordingly, the modules could be comprised of software, firmware, and/or hardware components implemented in, or accessible to, the system 1100. As shown, the modules include a predictive pricing engine (PPE) 1114, a simultaneous execution matching engine (SEME) 1116, an inventory management system (IMS) 1118, and a post-trade fill and allocation engine (PTFAE) 1120.

The PPE 1102 is a predictive engine deployed on a server and configured to observe underlying market liquidity in symbols that represent tradeable objects in a spread execution system. From these market observations, the PPE 1102 predicts a price value and a quantity value for a bid and an ask that are derived from a non-linear combination of factors that include, for example, top of book liquidity, depth liquidity, volatility, price stability, etc. The PPE 1102 generates predicted price values that are used to generate indicative fills in proxy instruments. In particular, the prices are predictive and have a continuous granularity that allows the SEME 1104 to generate these indicative fills at predicted prices that are not available on the electronic exchanges 1112. The PPE 1102 enables the system 1100 to price improve (e.g., tighten the bid/ask spread) versus the underlying exchanges or expand the bid/ask spread of the underlying exchanges based on the output of the non-linear predictive model for each symbol or instrument in the system.

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the PPE 1102 implements a model that can be a neural network with multiple input nodes that receives market data. The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input that, once the model is trained, can be used to predict price and quantity values. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes spread data as input and a desired output, such as a desired spread value. A representation of spread order can be provided to the model. Output from the model can be compared to the desired output for that spread and, based on the comparison, the model can be modified, such as by changing weights between nodes of the neural network or parameters of the functions used at each node in the neural network (e.g., applying a loss function). After applying data from each of the sources in the training data and modifying the model in this manner, the model can be trained to evaluate new market data.

The SEME 1104 includes software and/or hardware (e.g., software running on a server) and is configured to match user orders held in the system 1100's private limit order book. The SEME 1104 evaluates the individual representation of continuous pricing and size liquidity of all leg components of a spread order. The SEME 1104 uses the internal predictive markets created by the PPE 1102 on a leg-by-leg basis to generate a simultaneous indicative fill for each user-specified spread. These internal fills are generated “in balance” to the ratios defined on the spread order ticket.

The SEME 1104 creates a match between a user-specified spread order and theoretical prices of the PPE 1102, and the system 1100 distributes the inventory created in the internal virtual agents to the IMS 1106. The IMS 1106 includes software and/or hardware deployed on an electronic exchange co-located or proximate to a datacenter where exchange instruments corresponding to the internal virtual agents are traded. The IMS 1106 individually manages positions created in the SEME 1104. The positions can function passively in the market or actively across the market bid/ask spread based on market microstructure models and low latency market data. Once inventory is sent to the IMS 1106, execution timing becomes independent of any other instruments in the spread relationship. As a result, the system 1100 dramatically reduces message-to-fill ratios on the electronic exchanges 1110 and electronic communication networks (ECNs). That is, fewer messages are communicated from the system 1100 over the network 1112 to the electronic exchanges 1110, to complete fill operations. This limits network traffic (e.g., reduces network congestion), providing a benefit to ECNs and users alike.

The PTFAE 1108 allows the system 1100 to record indicative fills for internal storage with ownership identified to each user and to consolidate futures orders on the electronic exchanges 1110 into a single bundled order. The order bundling reduces messaging at the electronic exchange 1110, reduces latency on order actions based on the market microstructure signals, and improve the quality of the overall fill for the user. The PTFAE 1108 keeps an inventory of indicative fills and uses an exchange approved predetermined allocation scheme to direct executed trades in a bundled order back to the appropriate user that generated the indicative fills. The PTFAE 1108 can also generate average price fills in futures that can be allocated post-trade across a user's multiple different accounts in a perfectly equitable manner. The PTFAE 1108 can handle all calculations for markups and fees and includes these fees in the clearing price of the US Treasury securities legs.

The disclosed technology includes GUI enhancements. Examples include a ticket wizard (TW), a CIX (e.g., custom indices) converter (CC), futures implied yield settings (FIY), and net change tickets. The TW allows users to create an executable spread order ticket by entering the total quantity of each leg on the spread. The TW will automatically generate the factors and divisors that define the spread level. The TW also automatically slices the large parent order into the maximum number of slices that produce the minimum size of one unit of each leg per slice. The TW generates a perfect theoretic weighting of the total size on the ticket. Slicing allows a ticket to be filled gradually while maintaining the desired size ratio on each leg of the spread. This slicing minimizes market impact and improves overall execution. The TW allows for spread tickets in price, 32nds, yield and custom yield factor weighting.

Bloomberg allows users to create custom indices that graphically display a timeseries chart of the index. Bloomberg users create libraries of these CIX's to monitor potential trading opportunities. The CC is configured to read text in the syntax defined and used in the Bloomberg CIX to create executable spread orders that can be saved into the system's ExMode GUI workspace. This streamlines the ability for users of the system 1100 to create and execute trades when the market opportunity presents.

The system 1100 can create a single dashboard with the ExMode GUI to transform fixed income futures prices to a yield representation. The FIY allows users to choose the Cheapest to Deliver, delivery date and methods of Convention, Forward, or Conversion Factor Forward for transformation of price to yield values. The FIY allows users of the system 1100 to improve hedge risk in fixed income instruments with convexity by using the nonlinear representation of yield. Regarding the net change tickets, the system 1100 allows the spread level to be expressed and executed as an offset (net change) from the prior day settlement price of all legs comprising the spread.

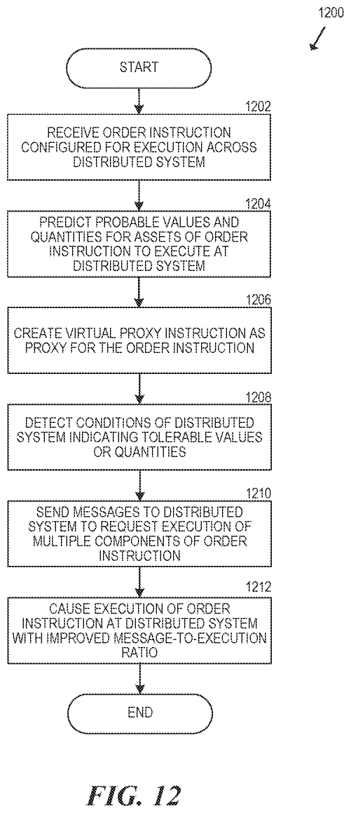

FIG. 12 is a flowchart that illustrates a process performed by a proxy system to execute a spread order in a distributed system. The proxy system can run on one or more servers to create a virtual proxy (e.g., synthetic risk proxy) for an order instruction (e.g., a spread order) having multiple component legs configured for execution on a distributed system (e.g., including electronic exchanges).

At 1202, the proxy system receives the order instruction, which combines multiple components configured for execution at one or more subsystems of the distributed system. The order instruction includes specified values and specified quantities for executing the multiple components at the one or more subsystems. The proxy system is communicatively coupled over one or more networks to the one or more subsystems.

At 1204, the proxy system predicts probable values and probable quantities for assets at which the proxy system is allowed to cause execution of the multiple components of the order instruction at the one or more subsystems. The probable values and probable quantities are outputs of a prediction engine that is trained based on dynamic data of the assets at the one or more subsystems. The probable value can be a guaranteed value removing upside and downside execution risk of failing. In one example, the probable value removes downside execution risk of failing below a first threshold and upside execution risk of failing above a second threshold. The probable values and the probable quantities can adapt in real-time based on changes at the one or more subsystems. In one example, predicting the probable values and the probable quantities includes automatically analyzing the asset data of the assets in real-time on the one or more subsystems.

At 1206, the proxy system creates a virtual proxy instruction that is a proxy for the order instruction and includes the probable values and the probable quantities that are proxies for the specified values and the specified quantities. The virtual proxy includes multiple components that dynamically change based on conditions affecting the multiple components of the order instruction. In one example, creating the virtual proxy instruction for the order instruction includes determining decimalized representations of the assets on one or more live electronic exchanges. The decimalized representations provide greater granular data compared to data available at the one or more subsystems. In one example, the decimalized representations are generated based on a request received from a user to a client device to determine a combination of the assets on the one or more subsystems. In one example, creating the virtual proxy instruction for the order instruction includes generating the virtual proxy instruction based on a profile of an entity that provides the specified value and the specified quantities, and consolidating the specified values and the specified quantities into a unit.

At 1208, the proxy system detects one or more conditions of the distributed system indicating that actual values or actual quantities of the assets at the one or more subsystems are within one or more tolerable thresholds relative to the probable values or the probable quantities of the virtual proxy instruction. In one example, detecting the conditions includes classifying the assets associated with the order instruction based on stability of the probable values and the probable quantities.

At 1210, in response to the one or more detected conditions, the proxy system sends, over the one or more communications networks to the one or more subsystems, messages to request execution of the multiple components of the order instruction. In one example, the proxy system can send, over the one or more communications networks, to a client device that provided the specified values and the specified quantities for executing the multiple components at the one or more subsystems, a request to accept execution of the virtual proxy instruction within the tolerable thresholds including the probable values and the probable quantities. The proxy system can receive, from the client device, an indication of acceptance to execute the virtual proxy instruction.

At 1212, the proxy system causes execution of the multiple components of the order instruction at the one or more subsystems based on the actual values and the actual quantities of the assets that are within the one or more tolerable thresholds relative to the probable values and the probable quantities. As such, the proxy system can insulate a user of the client device from a difference between a specified value and an actual value of an asset when the actual value does not equal the specified value. Execution of the order instruction can include attributing the actual value and an additional value (e.g., fee) to an account of a user of the client device. The actual values can be determined by classifying the assets based on their price stability.

The indirect execution of the multiple components based on the virtual proxy instruction improves a message-to-execution ratio compared to direct execution of the multiple components based on the order instruction. The message-to-execution ratio corresponds to a number of messages required to complete execution of the order instruction. Thus, for example, the virtual proxy can reduce the number of messages that are required to fill a spread order.

The proxy system can generate or administer, on the client device, a GUI having displayed thereon a status of the order instruction. In one example, the proxy system can stream, for display at the client device, data associated with real-time values or real-time quantities of the assets. The virtual proxy instruction is configured to be executed with the assets in a ratio defined in the order instruction despite a variance between the specified values and the specified quantities relative to the actual values and the actual quantities, respectively.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. In the event something in a reference contradicts something in this application, this application shall control.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

Certain aspects of the invention are presented below in certain claim forms, but the applicant contemplates the various aspects of the invention in any number of claim forms. For example, while only one aspect of the invention is recited as a means-plus-function claim under 35 U.S.C § 112, ¶6(f) (AIA), other aspects may likewise be embodied as a means-plus-function claim, or in other forms, such as being embodied in a computer-readable medium. Any claims intended to be treated under 35 U.S.C. § 112, ¶6(f) will begin with the words “means for”, but use of the term “for” in any other context is not intended to invoke treatment under 35 U.S.C. § 112, ¶6(f). Accordingly, the applicant reserves the right to pursue additional claims after filing this application.

I/We claim:

1. A computer-implemented method performed by a central proxy system for creating a virtual proxy for an order instruction having multiple components configured for execution on a distributed system, the method comprising:
receiving, at the proxy system running on one or more servers, the order instruction that combines multiple components configured for execution at one or more subsystems of the distributed system,
wherein the order instruction includes specified values and specified quantities for executing the multiple components at the one or more subsystems, and
wherein the proxy system is communicatively coupled over one or more networks to the one or more subsystems;
predicting probable values and probable quantities for assets at which the proxy system is allowed to cause execution of the multiple components of the order instruction at the one or more subsystems,
wherein the probable values and probable quantities are outputs of a prediction engine that is trained based on dynamic data of the assets at the one or more subsystems;
creating a virtual proxy instruction that is a proxy for the order instruction including the probable values and the probable quantities that are proxies for the specified values and the specified quantities,
wherein the virtual proxy includes multiple components that dynamically change based on conditions affecting the multiple components of the order instruction;
detecting one or more conditions of the distributed system indicating that actual values or actual quantities of the assets at the one or more subsystems are within one or more tolerable thresholds relative to the probable values or the probable quantities of the virtual proxy instruction;
in response to the one or more detected conditions, sending, over the one or more communications networks to the one or more subsystems,
messages to request execution of the multiple components of the order instruction; and
causing execution of the multiple components of the order instruction at the one or more subsystems based on the actual values and the actual quantities of the assets that are within the one or more tolerable thresholds relative to the probable values and the probable quantities,
wherein indirect execution of the multiple components based on the virtual proxy instruction reduces a message-to-execution ratio compared to direct execution of the multiple components based on the order instruction, and
wherein the message-to-execution ratio corresponds to a number of messages required to complete execution of the order instruction.

2. The computer-implemented method of claim 1 further comprising, prior to causing execution of the multiple components of the order instruction at the one or more subsystems:
sending, over the one or more communications networks, to a client device that provided the specified values and the specified quantities for executing the multiple components at the one or more subsystems, a request to accept execution of the virtual proxy instruction within the tolerable thresholds including the probable values and the probable quantities; and
receiving, from the client device, an indication of acceptance to execute the virtual proxy instruction.

3. The computer-implemented method of claim 2 further comprising:
streaming, for display at the client device, data associated with real-time values or real-time quantities of the assets,
wherein the virtual proxy instruction is configured to be executed with the assets in a ratio defined in the order instruction despite a variance between the specified values and the specified quantities relative to the actual values and the actual quantities, respectively.

4. The computer-implemented method of claim 2 further comprising:
insulating, at the proxy system, a user of the client device from a difference between a specified value and an actual value of an asset when the actual value does not equal the specified value.

5. The computer-implemented method of claim 2, wherein causing execution of the order instruction includes attributing the actual value and an additional value to an account of a user of the client device.

6. The computer-implemented method of claim 1, wherein determining the actual values includes classifying the assets based on stability.

7. The computer-implemented method of claim 1, wherein creating the virtual proxy instruction for the order instruction comprises:
determining decimalized representations of the assets on one or more live electronic exchanges.

8. The computer-implemented method of claim 7, wherein the decimalized representations provide greater granular data compared to data available at the one or more subsystems.

9. The computer-implemented method of claim 7, wherein the decimalized representations are generated based on a request received from a user to a client device to determine a combination of the assets on the one or more subsystems.

10. The computer-implemented method of claim 7, wherein the probable value is a guaranteed value removing upside and downside execution risk of failing.

11. The computer-implemented method of claim 1, wherein the probable value removes downside execution risk of failing below a first threshold and upside execution risk of failing above a second threshold.

12. The computer-implemented method of claim 1, wherein creating the virtual proxy instruction for the order instruction comprises:
generating the virtual proxy instruction based on a profile of an entity that provides the specified value and the specified quantities; and
consolidating the specified values and the specified quantities into a unit.

13. The computer-implemented method of claim 1 further comprising:
generating a graphical user interface having displayed thereon a status of the order instruction.

14. The computer-implemented method of claim 1, wherein predicting the probable values and the probable quantities comprises:
automatically analyzing the asset data of the assets in real-time on the one or more subsystems.

15. The computer-implemented method of claim 1, wherein the probable values and the probable quantities adapt in real-time based on changes at the one or more subsystems.

16. The computer-implemented method of claim 15, wherein detecting the one or more conditions comprises:
classifying the assets associated with the order instruction based on stability of the probable values and the probable quantities.

17. A computer-readable storage medium, excluding transitory signals and carrying instructions, which, when executed by at least one data processor of a proxy system, cause the proxy system to:
receive an order instruction that combines multiple components configured for execution across a distributed system of one or more subsystems,
wherein the order instruction includes specified values and specified quantities for executing the multiple components at the one or more subsystems, and
wherein the proxy system is communicatively coupled over one or more networks to the one or more subsystems;
predict probable values and probable quantities for assets at which the proxy system is allowed to cause execution of the multiple components of the order instruction at the one or more subsystems,
wherein the probable values and probable quantities are outputs of a prediction engine that is trained based on dynamic data of the assets at the one or more subsystems;
create a virtual proxy instruction that is a proxy for the order instruction including the probable values and the probable quantities that are proxies for the specified values and the specified quantities,
wherein the virtual proxy includes multiple components that dynamically change based on conditions affecting the multiple components of the order instruction;
detect one or more conditions of the distributed system indicating that actual values or actual quantities of the assets at the one or more subsystems are within one or more tolerable thresholds relative to the probable values or the probable quantities of the virtual proxy instruction;
in response to the one or more detected conditions, send, over the one or more communications networks to the one or more subsystems, messages to request execution of the multiple components of the order instruction; and
cause execution of the multiple components of the order instruction at the one or more subsystems based on the actual values and the actual quantities of the assets that are within the one or more tolerable thresholds relative to the probable values and the probable quantities,
wherein indirect execution of the multiple components based on the virtual proxy instruction reduces a message-to-execution ratio compared to direct execution of the multiple components based on the order instruction, and
wherein the message-to-execution ratio corresponds to a number of messages required to complete execution of the order instruction.

18. The computer-readable storage medium of claim 17, wherein the proxy system is further caused to:
send, over the one or more communications networks, to a client device that provided the specified values and the specified quantities for executing the multiple components at the one or more subsystems, a request to accept execution of the virtual proxy instruction within the one or more tolerable thresholds including the probable values and the probable quantities; and
receive, from the client device, an indication of acceptance to execute the virtual proxy instruction.

19. The computer-readable storage medium of claim 18, wherein the proxy system is further caused to:
stream, for display at the client device, data associated with real-time values or real-time quantities of the assets.

20. A proxy system comprising:
at least one hardware processor; and
at least one non-transitory memory storing instructions, which, when executed by the at least one hardware processor, cause the proxy system to:
receive an order instruction that combines multiple components configured for execution across a distributed system of one or more subsystems,
wherein the order instruction includes specified values and specified quantities for executing the multiple components at the one or more subsystems, and
wherein the proxy system is communicatively coupled over one or more networks to the one or more subsystems;
predict probable values and probable quantities for assets at which the proxy system is allowed to cause execution of the multiple components of the order instruction at the one or more subsystems,
wherein the probable values and probable quantities are outputs of a prediction engine that is trained based on dynamic data of the assets at the one or more subsystems;
create a virtual proxy instruction that is a proxy for the order instruction including the probable values and the probable quantities that are proxies for the specified values and the specified quantities,
wherein the virtual proxy includes multiple components that dynamically change based on conditions affecting the multiple components of the order instruction;
detect one or more conditions of the distributed system indicating that actual values or actual quantities of the assets at the one or more subsystems are within one or more tolerable thresholds relative to the probable values or the probable quantities of the virtual proxy instruction;
in response to the one or more detected conditions, send, over the one or more communications networks to the one or more subsystems, messages to request execution of the multiple components of the order instruction; and
cause execution of the multiple components of the order instruction at the one or more subsystems based on the actual values and the actual quantities of the assets that are within the one or more tolerable thresholds relative to the probable values and the probable quantities,
wherein indirect execution of the multiple components based on the virtual proxy instruction reduces a message-to-execution ratio compared to direct execution of the multiple components based on the order instruction, and
wherein the message-to-execution ratio corresponds to a number of messages required to complete execution of the order instruction.
